(19) United States
(12) Patent Application Publication
(10) Pub. No.: US 2025/0045385 A1
(43) Pub. Date: Feb. 6, 2025

(54) SYSTEM AND METHOD FOR TERMINATING RANSOMWARE BASED ON DETECTION OF ANOMALOUS DATA

(71) Applicant: INDIAN INSTITUTE OF TECHNOLOGY KANPUR, KANPUR (IN)

(72) Inventors: Putrevu Mohan Anand, Kanpur (IN); Putrevu Venkata Sai Charan, Kanpur (IN); Chunduri Naga Venkata Hrushikesh, Kanpur (IN); Sandeep Kumar Shukla, Kanpur (IN)

(21) Appl. No.: 18/655,498

(22) Filed: May 6, 2024

Related U.S. Application Data
(60) Provisional application No. 63/517,119, filed on Aug. 2, 2023.

(51) Int. Cl. G06F 21/55; G06F 21/56

(52) U.S. Cl. CPC G06F 21/554; G06F 21/565; G06F 2221/034

(57) ABSTRACT

A system and a method for terminating ransomware based on detection of anomalous data is disclosed. The system and the method comprise a registry activity monitoring subsystem, a file trap monitoring subsystem, a decision generating subsystem, and a termination subsystem. The registry activity monitoring subsystem is configured to generate first data and the file trap monitoring subsystem is configured to generate second data. The first data and the second data are transferred to the decision generating subsystem for retrieving Process IDs (PIDs) to initiate a ransomware termination process. Upon confirmation from the decision generating subsystem, the termination subsystem is configured to terminate the retrieved Process IDs (PIDs) to terminate the ransomware based on the detection of the anomalous data from one or more computing devices.

This application claims priority from a Provisional patent application filed in U.S. having Patent Application No. 63/517,119, filed on Aug. 2, 2023, and titled “SYSTEM FOR EARLY DETECTION AND TERMINATION OF RANSOMWARE AND METHOD THEREOF”

### TECHNICAL FIELD

Embodiments of the present disclosure relate to computer security and more particularly relate to a computer-implemented system and a method for terminating ransomware based on early detection of anomalous data in a registry and trap files.

### BACKGROUND

Computer systems are increasingly vulnerable to ransomware attacks, which pose significant threats to data security and integrity. The ransomware is a type of malicious software that encrypts files and blocks access to the computer systems, demanding payment for their release. These attacks are known as crypto ransomware attacks. In the recent past, the frequency and complexity of the crypto ransomware attacks have risen substantially, as the attacker employs different methods to infiltrate the computer or a network of the victim without being detected

The crypto ransomware attacks do not immediately encrypt the files on the computer or the network of the victim but first engage in preliminary actions. The preliminary actions include gathering system information of the victim such as operating system version, file system structure, installed software and network configuration, etc. The preliminary actions also include creating registry keys or scheduled tasks to ensure the crypto ransomware attacks continue running even after a system reboot, disabling security software on the computer or the network of the victim to avoid detection, and masquerading itself as a legitimate software. The registry stored significant data pertaining to recently accessed programs or files, user account credentials, network share connections, and other pertinent information. Examining the registry offers valuable insights into user activity timelines and potential data theft sources or malware activity. However, relying solely on changes in the registry level for ransomware detection has proven challenging. This is because crypto ransomware attacks typically involve scanning files for encryption while concurrently executing actions such as deleting shadow copies.

In an existing technology, an automated dynamic analysis of ransomware is disclosed. The analysis highlights the importance of registry key operations in detecting ransomware. The analysis found that the registry keys and application programming interface (API) statistics are crucial information for developing a reliable classifier to identify ransomware activity. However, the analysis failed to address substantial modifications made to the registry keys during ransomware execution. Most approaches in the analysis relied on the registry keys to not prioritize the pre-encryption behavior of the ransomware.

Similarly, an R-Locker: thwarting ransomware action through a honey file-based approach is disclosed. The R-Locker involves creating multiple symbolic links, or honey files, on a single trap file to counteract a ransomware activity. However, certain one or more ransomware variants bypassed the R-Locker by considering the size of the trap files. As a result, the honey files deployed by the R-Locker are excluded from the encryption process.

There are various technical problems with the detection and termination of ransomware attacks in the prior art. In the existing technology, detecting and mitigating ransomware attacks often relies on signature-based detection methods or heuristic analysis. The signature-based detection requires regular updates to keep pace with the evolving one or more ransomware variants, making it challenging to detect new and unknown threats. Heuristic analysis, on the other hand, may generate false positives or miss subtle indicators of ransomware activity. Furthermore, many existing systems focus on a post-infection remediation rather than proactive prevention, allowing ransomware to cause significant damage before detection. Delayed detection leads to data loss, financial loss, and disruption of critical operations, underscoring the need for more robust and proactive ransomware prevention mechanisms. Traditional detection methods fail to identify the early stages of the ransomware attacks, resulting in delayed response and potential data loss or encryption of critical files.

Therefore, there is a need for a system and a method to address the aforementioned issues by providing a proactive approach for detecting ransomware activity, blocking, and terminating ransomware attacks during the initial stages of encryption.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In order to overcome the above deficiencies of the prior art, the present disclosure is to solve the technical problem by providing a computer-implemented system and a method for terminating ransomware based on early detection of anomalous data in a registry and trap files.

In accordance with an embodiment of the present disclosure, the computer-implemented method for terminating ransomware based on early detection of the anomalous data is disclosed. In the first step, the computer-implemented method includes generating, by a registry activity monitoring subsystem, first data associated with the anomalous data based on analysis of registry data in one or more computing devices. The first data is generated upon detecting at least one of: key additions, value additions, and value updates in the registry data indicating a ransomware activity within a registry of the one or more computing devices.

In the next step, the computer-implemented method includes generating, by a file trap monitoring subsystem, second data associated with the anomalous data based on analysis of one or more trap files associated with one or more directory files in the one or more computing devices. The one or more trap files are produced based on at least one of: engaging a pre-existing one or more directory files and selecting additional trap files in the one or more directory files. The pre-existing one or more directory files comprises at least one of: system directories, user directories, and temporary directories to optimise the generation of the second data. The second data is generated based on analysing the one or more trap files by detecting at least one of a: file write, file delete, and file rename operations indicative of the ransomware activity within the one or more computing devices. The second data is generated based on detecting at least one of the: file write, file delete, and file rename operations of at least two trap files of the one or more trap files for averting false positive alerts.

The file trap monitoring subsystem is configured with data mining models to extract frequent file access patterns from historical file modification data associated with the one or more directory files for engaging the one or more trap files. The data mining models comprises at least one of: association rule mining, sequential pattern mining, and frequency rule mining to identify potential one or more trap file locations.

In the next step, the computer-implemented method includes retrieving, by a decision generating subsystem, Process IDs (PIDs) from at least one of a: Process ID (PID) Filter and Process ID (PID) Fetch associated with the first data and the second data to initiate a ransomware termination process. The decision generating subsystem is configured with a time synchronization module. The time synchronization module is configured to synchronise timestamps data associated with the first data and the second data to confirm the ransomware activity in the one or more computing devices. The timestamps data comprises a predetermined timeframe for receiving the second data upon receiving the first data. The predetermined timeframe ranges between 3 seconds and 10 seconds. The decision generating subsystem is configured with a restart module. The restart module is configured to restart the terminated Process IDs (PIDs) from at least one of the: Process ID (PID) Filter and Process ID (PID) Fetch if the decision-generating subsystem (114) detects the second data generation is beyond the predetermined timeframe.

In the next step, the computer-implemented method includes terminating, by a termination subsystem, the retrieved Process IDs (PIDs) from at least one of the: Process ID (PID) Filter and Process ID (PID) Fetch to terminate the ransomware based on detection of the anomalous data from the one or more computing devices. The termination subsystem comprises a prioritization module. The prioritization module is configured to prioritize the termination of the Process IDs (PIDs) from at least one of the: Process ID (PID) Filter and Process ID (PID) Fetch based on acuteness parameters of the ransomware activity.

In accordance with an embodiment of the present disclosure, the computer-implemented system for terminating ransomware based on the detection of the anomalous data is disclosed. The computer-implemented system comprises one or more hardware processors and a computer readable storage unit. The one or more hardware processors is operatively connected to the one or more computing devices. The computer readable storage unit is operatively connected to the one or more hardware processors. The computer readable storage unit comprises a set of program instructions in form of a plurality of subsystems. The plurality of subsystems configured to be executed by the one or more hardware processors. The plurality of subsystems comprises the registry activity monitoring subsystem, the file trap monitoring subsystem, the decision generating subsystem, and the termination subsystem.

In an embodiment, the registry activity monitoring subsystem is configured to generate the first data associated with the anomalous data based on analysing the registry data in the one or more computing devices. The file trap monitoring subsystem is configured to generate the second data associated with the anomalous data based on analysing one or more trap files associated with one or more directory files in the one or more computing devices. The decision generating subsystem is configured to initiate a ransomware termination process upon retrieving the Process IDs (PIDs) from at least one of the: Process ID (PID) Filter and Process ID (PID) Fetch associated with the first data and the second data. The termination subsystem is configured to terminate the retrieved Process IDs (PIDs) from at least one of the: Process ID (PID) Filter and Process ID (PID) Fetch for terminating the ransomware based on detection of the anomalous data from the one or more computing devices.

Yet in another embodiment, the computer-implemented system comprises a notification subsystem and a real-time monitoring subsystem. The notification subsystem is configured to generate one or more alerts based on termination of the Process IDs (PIDs) from at least one of the: Process ID (PID) Filter and Process ID (PID) Fetch. The real-time monitoring subsystem configured to update the computer-implemented system with updated ransomware behaviour patterns and one or more trap file selection strategies based on ongoing analysis of the registry data and the one or more directory files.

In accordance with an embodiment of the present disclosure, a non-transitory computer readable storage unit having instructions stored therein that when executed by the one or more hardware processors, cause the one or more hardware processors to execute operations of: (a) generating first data associated with the anomalous data based on analysis of registry data in one or more computing devices, (b) generating second data associated with the anomalous data based on analysis of one or more trap files associated with one or more directory files in the one or more computing devices, (c) retrieving Process IDs (PIDs) from at least one of a: Process ID (PID) Filter and Process ID (PID) Fetch associated with the first data and the second data to initiate a ransomware termination process, and (d) terminating the retrieved Process IDs (PIDs) from at least one of the: Process ID (PID) Filter and Process ID (PID) Fetch to terminate the ransomware based on detection of the anomalous data from the one or more computing devices.

To further clarify the advantages and features of the present disclosure, a more particular description of the present disclosure will follow by reference to specific embodiments thereof, which are illustrated in the appended figures. It is to be appreciated that these figures depict only typical embodiments of the present disclosure and are therefore not to be considered limiting in scope. The present disclosure will be described and explained with additional specificity and detail with the appended figures.

### BRIEF DESCRIPTION OF THE DRAWINGS

The disclosure will be described and explained with additional specificity and detail with the accompanying figures in which:

FIGS. 1A and 1B illustrate exemplary flowcharts of a computer-implemented method for terminating ransomware based on detection of anomalous data, in accordance with an embodiment of the present disclosure;

FIG. 1C illustrates an exemplary flowchart depicting one or more trap file selection strategies, in accordance with an embodiment of the present disclosure;

FIG. 2 illustrates an exemplary block diagram representation of a network architecture of a computer-implemented system for terminating ransomware based on detection of the anomalous data, in accordance with an embodiment of the present disclosure;

FIG. 3 illustrates an exemplary block diagram representation of the computer-implemented system as shown in FIG. 2 for terminating ransomware based on the detection of the anomalous data, in accordance with an embodiment of the present disclosure;

FIG. 4 illustrates an exemplary block diagram depicting a registry data extraction process, in accordance with an embodiment of the present disclosure;

FIG. 5 illustrates an exemplary first graphical flow diagram depicting a strategy for positioning one or more trap files in a depth-first traversal system (DFS) encryption order, in accordance with an embodiment of the present disclosure;

FIG. 6 illustrates an exemplary second graphical flow diagram depicting a strategy for positioning the one or more trap files in a breadth-first traversal system (BFS) encryption order, in accordance with an embodiment of the present disclosure; and

FIG. 7 illustrates an exemplary graphical representation depicting a comparison of latency between a registry activity monitoring subsystem and a file trap monitoring subsystem, in accordance with an embodiment of the present disclosure.

Further, those skilled in the art will appreciate that elements in the figures are illustrated for simplicity and may not have necessarily been drawn to scale. Furthermore, in terms of the method steps, chemical compounds, equipments and parameters used herein may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE PRESENT DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more components, compounds, and ingredients preceded by “comprises . . . a” does not, without more constraints, preclude the existence of other components or compounds or ingredients or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Before explaining at least one embodiment of the present disclosure in detail, it is to be understood that the present disclosure is not necessarily limited in its application to the details of construction and the arrangement of the components and/or methods set forth in the following description and/or illustrated in the drawings and/or the Examples. The present disclosure is capable of other embodiments or of being practiced or carried out in various ways.

Embodiments of the present disclosure relate to a computer-implemented system and a method for terminating ransomware based on early detection of anomalous data in a registry and trap files.

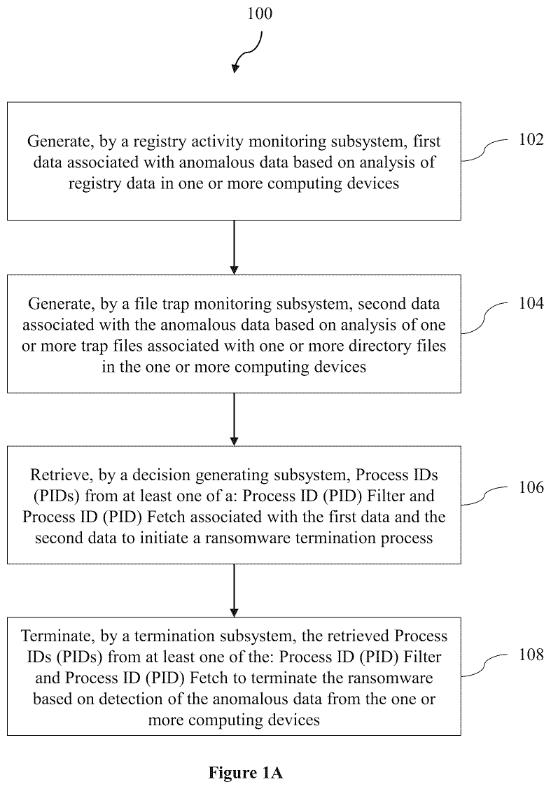

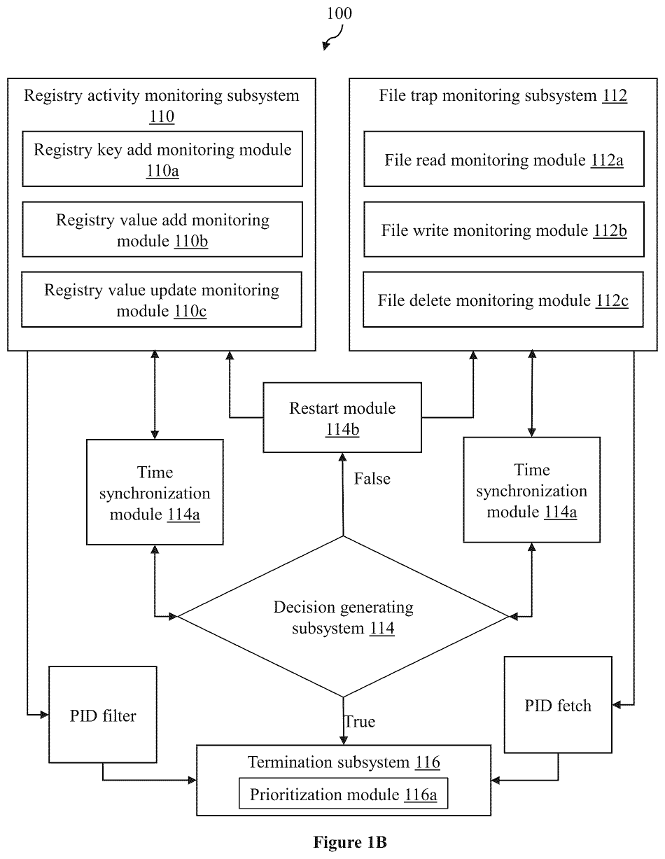

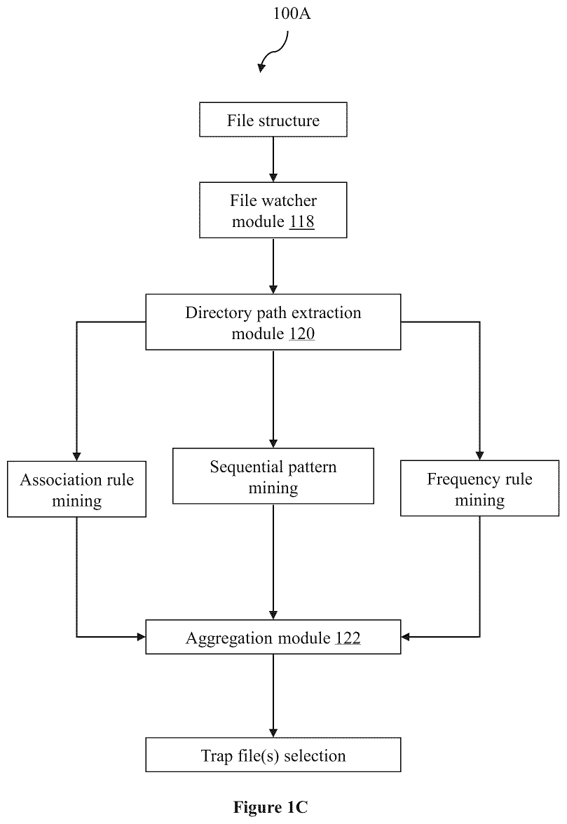

FIGS. 1A and 1B illustrate exemplary flowcharts of the computer-implemented method 100 for terminating ransomware based on detection of the anomalous data, in accordance with an embodiment of the present disclosure.

FIG. 1C illustrates an exemplary flowchart depicting one or more trap file selection strategies 100A, in accordance with an embodiment of the present disclosure.

The computer-implemented method 100 may include a computer readable storage unit (or media) having a set of program instructions thereon for causing one or more hardware processors to carry out aspects of the present disclosure. The computer readable storage unit may be a tangible device that may retain and store instructions for use by an instruction execution device. The computer readable storage unit may be, for example, but not limited to, an electronic storage device, a magnetic storage device, an optical storage device, an electromagnetic storage device, a semiconductor storage device, or any suitable combination of the foregoing.

The set of program instructions described herein may be downloaded to respective one or more computing devices from one of: the computer readable storage unit, an external computer, and an external storage device via a communication network. The communication network may include one of an: internet, local area network, wide area network and/or a wireless network and the like.

The set of program instructions may execute entirely on the one or more computing devices associated with users, partly on the one or more computing devices associated with the users, as a stand-alone software package, partly on a remote computer or entirely on the remote computer or server. In the latter scenario, the remote computer may be connected to the one or more computing devices associated with the users through the communication network.

Aspects of the present disclosure are described herein with reference to flowchart illustrations and/or block diagrams of the computer-implemented method 100, according to embodiments of the disclosure. It may be understood that each block of the flowchart illustrations and/or block diagrams, and combinations of blocks in the flowchart illustrations and/or block diagrams, may be implemented by the set of program instructions.

The flowchart and block diagrams in FIGS. 1A to 7 illustrate the architecture, functionality, and operation of possible implementations of the computer-implemented method 100 and the computer-implemented system according to various embodiments of the present disclosure. In this regard, each block in the flowchart or block diagrams may represent a plurality of subsystems, which comprises the set of program instructions for implementing the specified logical function(s). In some alternative implementations, the modules disclosed in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by the computer-implemented system that performs the specified functions or acts or carries out combinations of the one or more hardware processors and the set of program instructions.

In an exemplary embodiment, the plurality of subsystems comprises a registry activity monitoring subsystem 110, a file trap monitoring subsystem 112, a decision generating subsystem 114, and a termination subsystem 116. The plurality of subsystems configured to be executed by the one or more hardware processors, allowing for efficient processing and coordination of tasks related to the ransomware detection and termination.

Reference is now made to FIG. 1, which illustrates the computer-implemented method 100 for terminating ransomware based on early detection of the anomalous data is disclosed. At step 102 of the computer-implemented method 100, the registry activity monitoring subsystem 110 is configured to initiate a process by analysing registry data within the one or more computing devices for generating first data associated with the anomalous data. The registry activity monitoring subsystem 110 is configured to meticulously scrutinize the registry, a critical component of an operating system that stores configuration settings, options, and preferences for both the operating system and applications. During this registry data analysis, the registry activity monitoring subsystem 110 focuses on detecting specific types of modifications within the registry data that may indicate a presence of ransomware activity for generating the first data. The specific types of modifications may include key additions, value additions, and value updates.

In an exemplary embodiment, the registry activity monitoring subsystem 110 comprises a registry key add monitoring module 110a, a registry value add monitoring module 110b, and a registry value update monitoring module 110c. The registry key add monitoring module 110a is configured to focus on detecting the addition of unfamiliar registry keys. These registry keys serve as hierarchical containers within the registry, organizing various data related to system configurations, user preferences, and installed applications. By monitoring key additions, the registry key add monitoring module 110a is able to identify any unauthorized or suspicious modifications to the registry structure, which may indicate the presence of ransomware activity. The registry key add monitoring module 110a is configured to track the generation of new registry keys, encompassing various areas within the registry. The various areas include, but are not limited to, a volume shadow copy service (VSS), run key, AppCompatFlags, operating system script host (WSH), restart manager, RecentDocs, class and icon, boot configuration data (BCD), background activity moderator (BAM), shell bags, GlobalAssocChangedCounter, InstalledWin32AppsRevision, and the like.

Similarly, the registry value add monitoring module 110b is tasked with monitoring the addition of new values within existing registry keys. The registry values store at least one of, but not limited to, configuration settings, options, and parameters that dictate the behaviour of the operating system and the installed applications. Any unauthorized addition of values, especially within critical registry keys, could signify malicious activity by the ransomware seeking to alter the configurations of the one or more computing devices or execute malicious commands.

Lastly, the registry value update monitoring module 110c is configured to detect at least one of: updates and modifications to existing registry values. The ransomware may attempt to modify registry values to achieve various objectives, such as establishing persistence, disabling security mechanisms, or configuring encryption parameters. By monitoring value updates, the registry value update monitoring module 110c is able to identify suspicious changes to registry settings and trigger alerts for further investigation and termination.

At step 104 of the computer-implemented method 100, the file trap monitoring subsystem 112 is configured to generate second data associated with the anomalous data. The second data is generated based on the analysis of one or more trap files associated with one or more directory files within the one or more computing devices. The one or more trap files are produced based on at least one of: engaging a pre-existing one or more directory files and selecting additional trap files in the one or more directory files. The pre-existing one or more directory files comprises at least one of, but not limited to, system directories, user directories, and temporary directories to optimise the generation of the second data.

The second data is generated based on analysing the one or more trap files by detecting at least one of a: file write, file delete, and file rename operations indicative of the ransomware activity within the one or more computing devices. To ensure the reliability of the generated second data and minimize false positives, the file trap monitoring subsystem 112 implements a stringent criterion. Specifically, the second data is only generated when at least two trap files of the one or more trap files exhibit at least one of the: file write, file delete, and file rename operations. This criterion serves to avert false positive alerts by requiring multiple trap files to be affected, thereby enhancing the accuracy and effectiveness of the ransomware detection mechanism.

In an exemplary embodiment, the file trap monitoring subsystem 112 comprises a file read monitoring module 112a, a file write monitoring module 112b, and a file delete monitoring module 112c. The file read monitoring module 112a is configured to track and analyse file read operations performed on the one or more trap files. The file read monitoring module 112a continuously monitors the one or more trap files to detect any instances where they are being accessed and read by processes within the one or more computing devices. By closely monitoring file-read activities, the file trap monitoring subsystem 112 is able to identify potential ransomware behaviour, such as reconnaissance or scanning activities aimed at identifying files for encryption. The file read monitoring module 112a vastly assists in distinguishing a legitimate file access from potentially malicious behaviour exhibited by the ransomware attack or other unauthorized programs.

Similarly, the file write monitoring module 112b is adapted to monitor file write operations performed on the one or more trap files. Whenever an attempt is made to modify or write data to the one or more trap files, the file write monitoring module 112b actively captures and analyses the file write operations. By closely monitoring file write operations on the one or more trap files, the file write monitoring module 112b enables the detection of suspicious activity associated with the ransomware attempting to encrypt files or manipulate configurations of the one or more computing devices. Additionally, the file delete monitoring module 112c is configured to monitor file deletion operations performed on the one or more trap files. The file delete monitoring module 112c actively examines any attempts made to delete or remove the one or more trap files from the one or more computing devices. By detecting such file deletion operations, the file delete monitoring module 112c ensures that any unauthorized or unexpected removal of the one or more trap files is quickly identified.

In an exemplary embodiment, the file trap monitoring subsystem 112 is configured with data mining models. The data mining models are configured to extract frequent file access patterns from historical file modification data associated with the pre-existing one or more directory files for engaging the one or more trap files. The data mining models comprises at least one of, but not limited to, association rule mining, sequential pattern mining, frequency rule mining, and the like to identify the potential one or more trap file locations.

The selection of one or more trap files is a critical aspect of detecting ransomware. Understanding the behaviour of the one or more ransomware variants on the pre-existing one or more directory files during encryption is fundamental to this process. The one or more ransomware variants exhibit dynamic behaviour, which motivated the adoption of a non-heuristic approach in the one or more trap files selection.

To systematically select one or more trap files, the file trap monitoring subsystem 112 is configured with a file watcher module 118. The file watcher module 118 is capable of monitoring the one or more computing devices for file modifications. The file watcher module 118 is configured to record the corresponding file path and timestamp for each modification, enabling the extraction of the initial at least one hundred file changes includes at least one of the: file write, file delete, and file rename operations made by the specific ransomware variants of the one or more ransomware variants. Subsequently, the ordered list of directory paths is extracted from the pre-existing one or more directory files obtained from the file watcher module 118 using a directory path extraction module 120. The directory path extraction module 120 generates a unique and ordered list of directory paths for each ransomware variant.

The data mining models are applied to the ordered list of unique directory paths generated by the directory path extraction module 120. The association rule mining is based on a Apriori algorithm. The Apriori algorithm stands as a foundational method in the realm of data mining and association rule learning, particularly crucial in extracting meaningful insights from the pre-existing one or more directory files characterized by numerous transactions. The primary objective of the Apriori algorithm is to uncover frequent itemsets within a dataset and derive association rules, shedding light on patterns and relationships among different elements.

At its core, the Apriori algorithm operates iteratively, starting with the discovery of frequent 1-itemsets and progressively expanding to larger itemsets in subsequent iterations. This iterative process capitalizes on the “apriori” property, which posits that if an itemset is frequent, then all of its subsets must also be frequent. Leveraging this property, the Apriori algorithm efficiently prunes the search space, focusing only on itemsets with the potential to be frequent. In the computer-implemented method 100, each ransomware is treated as a transaction, with a set of targeted directory paths forming an itemset. For instance, a transaction attributed to a ransomware variant like AvosLocker may comprise a set of directory paths such as {{path5}, {path6}, {path2}, {path8}}, where each “path” denotes a directory of the pre-existing one or more directory files.

The Apriori algorithm relies on two fundamental concepts: Support and Confidence. Support measures the frequency of occurrence of an itemset, indicating how prevalent it is across all transactions. Confidence, on the other hand, assesses the likelihood of one itemset (A) leading to another (B) in a transaction, providing insights into the strength of association between different itemsets. Upon iteratively discovering frequent itemsets and computing association rules, the Apriori algorithm proceeds to prune the generated rules based on predefined thresholds for support and confidence. The top K rules, selected based on these metrics, are then forwarded to an aggregation module 122 for further processing.

Support S(X)=(Transactions containing X)/(Total Transactions)

Confidence C(A→B)=(S(A∪B))/(S(A))
Where, A and B are itemsets

The sequential pattern mining, exemplified by a PrefixSpan algorithm, is a vital technique for uncovering patterns in the pre-existing one or more directory files where the order of items holds significance. In the realm of ransomware analysis, where understanding the pre-existing one or more directory files file paths is pivotal, the sequential pattern mining performances a crucial role. By treating each ransomware sample's ordered file paths as a sequence, the sequential pattern mining leverage the PrefixSpan algorithm to identify frequent sequential patterns across ransomware samples, shedding light on common sequences of directory paths prevalent in the pre-existing one or more directory files.

To delve into the process, S: Represents a set of all ransomware samples. Si: Denotes the ordered sequence of file paths for the i^{th} ransomware sample. F: Signifies the set of frequent sequential patterns. For each pattern (P), the support value (s(P)) is determined, representing the number of ransomware samples in which the pattern is found. Formally, s(P) is defined as the count of Si in S such that P is a subsequence of Si. Utilizing the calculated support values (s(P)), the PrefixSpan algorithm generates a set of frequent sequential patterns (F), with each pattern accompanied by its support count. This set of frequent sequential patterns (F) captures recurring sequences of directory paths observed across ransomware samples.

For instance, consider a frequent sequential pattern P, such as {path2, path6}, with a support values (s(P)) is 10. This indicates that in 10 ransomware samples, the order {path2, path6} occurs frequently. Such insights are invaluable for understanding the behaviour of one or more ransomware variants, particularly their targeting of specific file paths in a particular order. From the obtained list of frequent sequential patterns (F) as depicted below, the top-K patterns are selected. These represent the most significant and recurring sequences of directory paths across ransomware samples.

F={(P1,s(P1)),(P2,s(P2)), . . . }

Each selected frequent sequential pattern is dissected to extract its individual directory paths. These paths hold critical information regarding the sequence of file operations performed by the one or more ransomware variants. Finally, the extracted directory paths from the top-K patterns are passed to the aggregation module 122 for further processing. The aggregation module 122 consolidates the directory paths obtained from both the Apriori algorithm and the PrefixSpan algorithm, facilitating the selection of the one or more trap files for ransomware detection and termination.

In an exemplary embodiment, a corner case search methodology addresses potential oversights in directory path extraction by the Apriori algorithm and the PrefixSpan algorithm, ensuring the one or more trap file selection strategies 100A for ransomware detection. While the Apriori algorithm and the PrefixSpan algorithm excel in capturing prevalent patterns and associations, they may overlook critical corner cases characterized by low-frequency yet high-order directory paths.

Consider a scenario with(S): the set of all ransomware samples. (S_i): the ordered sequence of file paths for the i^{th} ransomware sample. There may exist a single path (P) belonging to only a few ransomware samples (e.g., (S_2) and (S_{19})). where certain directory paths (P) are observed infrequently across ransomware samples but hold significant importance due to their high order. These directory paths (P), while less frequent, often signify the initiation of file changes by the one or more ransomware variants. To tackle such corner cases, the corner case search method begins by extracting the first ‘M’ directory paths from all ransomware samples' ordered sequences (S_i) (where (i=1) to (N)). This step ensures the inclusion of potentially overlooked paths with low frequencies but high orders. The corner case search method initializes by creating empty lists for storing the extracted directory paths and the final selection of important directory paths. For each ransomware sample, the first ‘M’ directory paths from its ordered sequence are extracted and appended to the list of M_directory_paths. This step captures the initial file modifications made by the ransomware during its execution, and this information is obtained from the file watcher module 118. Every unique directory path in the M_directory_paths list undergoes a corner case search. This involves evaluating the frequency of each path across all samples and sorting them in reverse order of frequency. Paths with low frequencies but high orders are prioritized. From the sorted list of directory paths, the top-K paths with the lowest frequency are selected. These paths represent corner cases with rare occurrences but significant implications for ransomware behaviour. The final selection of important-K directory paths is returned as the output, ensuring comprehensive coverage of the potential one or more trap file locations. These paths are then passed to the aggregation module 122 for further processing and the one or more trap file selection strategies 100A. The algorithm for the corner case search method is detailed in Algorithm 1.

### Algorithm 1

1. Input:
   (S): Set of all ransomware samples.
   (N): Number of ransomware samples.
   (M): Number of directory paths to extract from each (S_i).
   (K): Number of important directory paths to be extracted.
2. Initialization:
   Initialize an empty list (M_directory_paths).
   Initialize an empty list (important_K_directory_paths).
3. Extract M Directory Paths:
   For each ransomware sample (S_i) in(S):
      Extract the first ‘M’ directory paths ((M_paths_i)) from the ordered sequence (S_i).
      Append (M_paths_i) to (M_directory_paths).
4. Corner Case Search:
   For each unique directory path (P_i) in (M_directory_paths):
      Identify the frequency of (P_i) (i.e., (f(P_i))) across all paths in (M_directory_paths).
      Sort the frequency of (f(P_i)) in reverse order (lowest to highest) and store it in (rf(P_i)).
5. Extract Important-K Directory Paths:
   Extract the first (K) directory paths from (rf(P_i)) and store them in (important_K_paths).
6. Output:
   Return (important_K_paths) as the list of important-K directory paths.

The Algorithm 1, ensures that, in step 5, selects the top-K directory paths with the lowest frequency, emphasizing those with rare occurrences but significant impact in the order of ransomware effects.

In an exemplary embodiment, the aggregation module 122 is configured to extract the directory paths from association rules generated by the Apriori algorithm and sequential rules generated by the Prefixspan algorithm. The extracted directory paths are stored in a list called trap directories associated with the pre-existing one or more directory files. Additionally, the important-k directory paths from the corner case search method is included in the trap directories list. In the next step, the aggregation module 122 identify the unique directory paths in the trap directories list, which represent potential locations for selecting the one or more trap files. Finally, the one or more trap files in these trap directories list is selected based on one of, but not limited to, an alphabetical order, reverse alphabetical order, numeric file names, file size constraints and the like. The total number of one or more trap files selected, based on K values, is listed in Table 1. Some of the trap directories at some endpoints have only a few files (less than 3), which impacts the total number of selected one or more trap files, as indicated in Table 1.

TABLE 1

| | Count of unique Trap | Total number of trap |
|---|---|---|
| K Value | Directories | files selected |
| 2 | 4 | 15 |
| 3 | 6 | 22 |
| 4 | 9 | 34 |

The file trap monitoring subsystem 112 is configured to maintain the same names and extensions of the selected one or more trap files without any alterations. These one or more trap files are utilized for detecting at least one of the: file write, file delete, and file rename operations. For the evaluation of the computer-implemented method 100, the K value of 4 is selected to ensure that the one or more trap files attract the one or more ransomware variants.

At step 106 of the computer-implemented method 100, the decision-generating subsystem 114 is configured to initiate a ransomware termination process by retrieving Process IDs (PIDs) from at least one of a: Process ID (PID) Filter and Process ID (PID) Fetch associated with the first data and the second data. The decision generating subsystem 114 is configured with a time synchronization module 114a. The time synchronization module 114a is configured to synchronise timestamps data associated with the first data and the second data received from the registry activity monitoring subsystem 110 and the file trap monitoring subsystem 112 respectively. By synchronizing these timestamp data of the first data and the second data, the decision-generating subsystem 114 is able to effectively validate the occurrence of ransomware activity in the one or more computing devices within the predetermined timeframe. The predetermined timeframe ranges between 3 seconds and 10 seconds. This predetermined timeframe provides an information during which the second data is received following the detection of the first data. This stringent timeframe data ensures prompt detection and response to ransomware threats, minimizing the potential false positive impact on the detection of the ransomware.

The PID Filter is obtained from registry activity monitoring subsystem 110, where the PID filter is configured to identify the suspicious process IDs responsible for abnormal registry changes including key additions, value additions, and value updates. On the other hand, the PID Fetch is obtained from file trap monitoring subsystem 112. The PID Fetch is configured to identify the responsible process IDs behind trap file modifications and sends the process IDs to the ransomware PID termination module. The prioritization module is configured to move the obtained process IDs from the PID Fetch to a suspended state immediately to minimize the file loss.

Furthermore, the decision-generating subsystem 114 is configured with a restart module 114b. The restart module 114b is configured to restart the terminated Process IDs (PIDs) from at least one of the: Process ID (PID) Filter and Process ID (PID) Fetch if the decision-generating subsystem 114 detects the second data generation is beyond the predetermined timeframe. By restarting these terminated PIDs, the computer-implemented method 100 aims to restore the affected processes to their normal state, thereby mitigating the potential impact on the one or more computing devices. If the second data is generated within the predetermined timeframe and received the first data, the decision-generating subsystem 114 proceeds to a termination phase for terminating the ransomware.

At step 108, the computer-implemented method 100 progresses to the termination phase, facilitated by the termination subsystem 116. This step involves the decisive action of terminating the retrieved Process IDs (PIDs) obtained from at least one of the: Process ID (PID) Filter and Process ID (PID) Fetch, thus effectively halting the ransomware based on detection of the anomalous data from the one or more computing devices. The termination subsystem 116 comprises a prioritization module 116a. The prioritization module 116a is meticulously configured to prioritize the termination of the identified Process IDs (PIDs). This prioritization is governed by a set of acuteness parameters meticulously designed to evaluate the severity and urgency of the ransomware activity detected within the one or more computing devices.

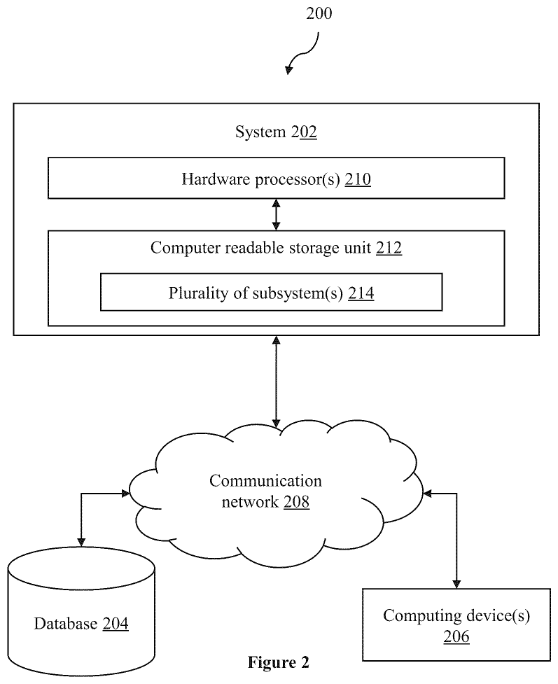

FIG. 2 illustrates an exemplary block diagram representation of a network architecture 200 of the computer-implemented system 202 for terminating ransomware based on detection of the anomalous data, in accordance with an embodiment of the present disclosure.

According to an exemplary embodiment of the disclosure, FIG. 2, the network architecture 200 may include the computer-implemented system 202, a database 204, and the one or more computing devices 206. The computer-implemented system 202 may be communicatively coupled to the database 204, and the one or more computing devices 206 via the communication network 208. The communication network 208 may be a wired communication network and/or the wireless communication network. The database 204 may include, but not limited to, storing, and managing data crucial for the functionality of the computer-implemented system 202. This includes storing and managing data related to ransomware detection algorithms, historical registry data, trap file configurations, anomalous data patterns, as well as system logs and performance metrics. The database 204 may be any kind of database such as, but not limited to, relational databases, non-relational databases, graph databases, document databases, dedicated databases, dynamic databases, monetized databases, scalable databases, cloud databases, distributed databases, any other databases, and a combination thereof.

In an exemplary embodiment, the one or more computing devices 206 may be associated with, but not limited to, one or more service providers, one or more customers, an individual, one or more users, an administrator, a vendor, a technician, a worker, a specialist, an instructor, a supervisor, a team, an entity, an organization, a company, a facility, a bot, any other user, and combination thereof. The entities, the organization, and the facility may include, but not limited to, an e-commerce company, online marketplaces, service providers, retail stores, a merchant organization, a logistics company, warehouses, transportation company, an airline company, a hotel booking company, a hospital, a healthcare facility, an exercise facility, a laboratory facility, a company, an outlet, a manufacturing unit, an enterprise, an organization, an educational institution, a secured facility, a warehouse facility, a supply chain facility, any other facility/organization and the like.

The one or more computing devices 206 may be used to provide input and/or receive output to/from the computer-implemented system 202, and/or to the database 204, respectively. The one or more computing devices 206 may be configured with one or more user interfaces to interact with the computer-implemented system 202 and/or to the database 204 for early detection and termination of ransomware. The one or more computing devices 206 may be at least one of, an electrical, an electronic, and an electromechanical. The one or more computing devices 206 may include, but is not limited to, a mobile device, a smartphone, a tablet computer, a laptop, a desktop, and the like configured with a Windows operating system.

Further, the computer-implemented system 202 may be implemented by way of a single device or a combination of multiple devices that may be operatively connected or networked together. The computer-implemented system 202 may be implemented in hardware or a suitable combination of a hardware and a software. The computer-implemented system 202 includes the one or more hardware processors 210, and the computer readable storage unit 212. The computer readable storage unit 212 may include the plurality of subsystems 214. The computer-implemented system 202 may be a hardware device including the one or more hardware processors 210 executing machine-readable program instructions for dynamically recommending course of action sequences to terminate ransomware based on the detection of the anomalous data. Execution of the machine-readable program instructions by the one or more hardware processors 210 may enable the computer-implemented system 202 to dynamically recommend course of action sequence for terminating the ransomware. The “hardware” may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or on one or more processors.

The one or more hardware processors 210 may include, for example, microprocessors, microcomputers, microcontrollers, digital signal processors, central processing units, state machines, logic circuits, and/or any devices that manipulate data or signals based on operational instructions. Among other capabilities, the one or more hardware processors 210 may fetch and execute computer-readable instructions in the computer readable storage unit 212 operationally coupled with the computer-implemented system 202 for performing tasks such as data processing, input/output processing, and/or any other functions. Any reference to a task in the present disclosure may refer to an operation being or that may be performed on data.

Though few components and subsystems are disclosed in FIG. 2, there may be additional components and subsystems which is not shown, such as, but not limited to, ports, routers, repeaters, firewall devices, network devices, databases, network attached storage devices, servers, assets, machinery, instruments, facility equipment, emergency management devices, image capturing devices, any other devices, and combination thereof. The person skilled in the art should not be limiting the components/subsystems shown in FIG. 2. Although FIG. 2 illustrates the computer-implemented system 202, and the one or more computing devices 206 connected to the database 204, one skilled in the art can envision that the computer-implemented system 202, and the one or more computing devices 206 may be connected to several user devices located at various locations and several databases 204 via the communication network 208.

Those of ordinary skilled in the art will appreciate that the hardware depicted in FIG. 2 may vary for particular implementations. For example, other peripheral devices such as an optical disk drive and the like, local area network (LAN), wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the computer-implemented system 202 as is unique to the present disclosure or necessary for an understanding of the present disclosure is depicted and described. The remainder of the construction and operation of the computer-implemented system 202 may conform to any of the various current implementations and practices that were known in the art.

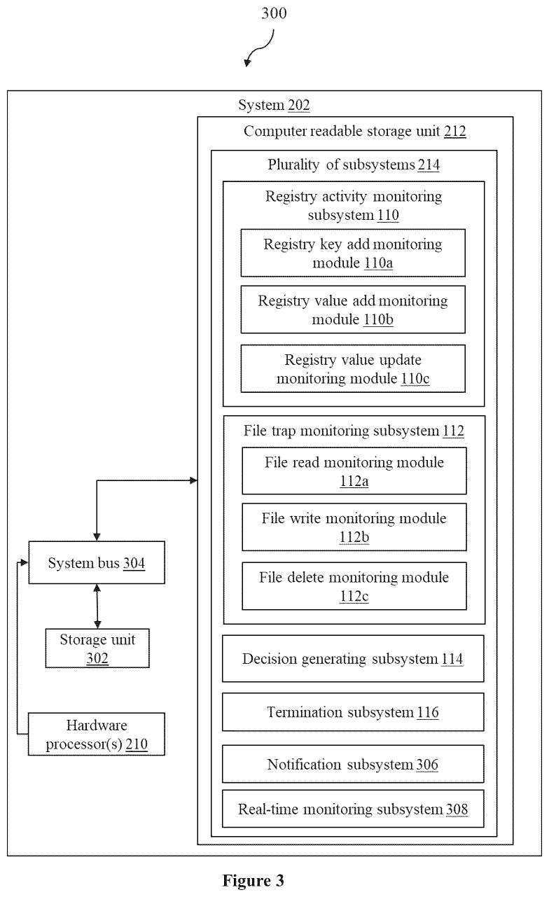

FIG. 3 illustrates an exemplary block diagram representation 300 of the computer-implemented system 202 as shown in FIG. 2 for terminating ransomware based on the detection of the anomalous data, in accordance with an embodiment of the present disclosure.

In an exemplary embodiment, the computer-implemented system 202 (hereinafter referred to as the system 202). The system 202 comprises the one or more hardware processors 210, the computer readable storage unit 212, and a storage unit 302. The one or more hardware processors 210, the computer readable storage unit 212, and the storage unit 302 are communicatively coupled through a system bus 304 or any similar mechanism. The computer readable storage unit 212 is operatively coupled to the one or more hardware processors 210. The computer readable storage unit 212 comprises the plurality of subsystems 214 in form of programmable instructions executable by the one or more hardware processors 210.

The plurality of subsystems 214 comprises the registry activity monitoring subsystem 110, the file trap monitoring subsystem 112, the decision generating subsystem 114, and the termination subsystem 116.

The one or more hardware processors 210, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 210 may also include embedded controllers, such as generic or programmable logic devices or arrays, application-specific integrated circuits, single-chip computers, and the like.

The computer readable storage unit 212 may be a non-transitory volatile memory and a non-volatile memory. The computer readable storage unit 212 may be coupled to communicate with the one or more hardware processors 210, such as being a computer-readable storage medium. The one or more hardware processors 210 may execute machine-readable instructions and/or source code stored in the computer readable storage unit 212. A variety of machine-readable instructions may be stored in and accessed from the computer readable storage unit 212. The computer readable storage unit 212 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the computer readable storage unit 212 includes the plurality of subsystems 214 stored in the form of machine-readable instructions on any of the above-mentioned storage media and may be in communication with and executed by the one or more hardware processors 210.

The storage unit 302 may be a cloud storage or the database 204 such as those shown in FIG. 2. The storage unit 302 may store, but not limited to, recommending a course of action sequences, applications, application links, application name, application description, application meta-data, application identifier, display name of the one or more applications, short textual description, a universal resource locator (URL) of the one or more applications, and a list of parameters corresponding to application context, generated recommending course of action sequences, one or more clickable elements, completion status of initiated user action through recommended course of action sequences, feedback loops, feedback from users, query parameters, additional query parameters, deep integration parameters, up-sell/x-sell product links, tracked user click-through rates, any other data, and combinations thereof. The storage unit 302 may be any kind of database such as, but not limited to, relational databases, dedicated databases, dynamic databases, monetized databases, scalable databases, cloud databases, distributed databases, any other databases, and a combination thereof.

In an exemplary embodiment, the registry activity monitoring subsystem 110 is configured to generate the first data associated with the anomalous data based on analysing the registry data in the one or more computing devices 206. The first data is generated upon detecting at least one of the: key additions, value additions, and value updates in the registry data indicating the ransomware activity within the registry of the one or more computing devices 206.

In an exemplary embodiment, the file trap monitoring subsystem 112 is configured to generate second data associated with the anomalous data based on analysing the one or more trap files. The one or more trap files is associated with the one or more directory files in the one or more computing devices 206. The one or more trap files are produced based on at least one of the: engaging a pre-existing one or more directory files and selecting additional trap files in the one or more directory files. The pre-existing one or more directory files comprises at least one of the: system directories, user directories, and temporary directories to optimise the generation of the second data. The second data is generated based on analysing the one or more trap files by detecting at least one of the: file write, file delete, and file rename operations indicative of the ransomware activity within the one or more computing devices 206. The second data is generated based on detecting at least one of the: file write, file delete, and file rename operations of at least two trap files of the one or more trap files for averting false positive alerts.

The file trap monitoring subsystem 112 is configured with data mining models. The data mining models are configured to extract frequent file access patterns from historical file modification data associated with the one or more directory files for engaging the one or more trap files. The data mining models comprises at least one of the: association rule mining, sequential pattern mining, and frequency rule mining to identify the potential one or more trap file locations.

In an exemplary embodiment, the decision generating subsystem 114 is configured to initiate the ransomware termination process upon retrieving Process IDs (PIDs) from at least one of the: Process ID (PID) Filter and Process ID (PID) Fetch associated with the first data and the second data. The decision generating subsystem 114 is configured with the time synchronization module 114a. The time synchronization module 114a is configured to synchronise the timestamps data associated with the first data and the second data to confirm the ransomware activity in the one or more computing devices 206. The timestamps data comprises the predetermined timeframe for receiving the second data upon receiving the first data. The predetermined timeframe ranges between 3 seconds and 10 seconds.

In an exemplary embodiment, the decision generating subsystem 114 is configured with the restart module 114b. The restart module 114b is configured to restart the terminated Process IDs (PIDs) from at least one of the: Process ID (PID) Filter and Process ID (PID) Fetch if the decision-generating subsystem 114 detects the second data generation is beyond the predetermined timeframe.

In an exemplary embodiment, the termination subsystem 116 is configured to terminate the retrieved Process IDs (PIDs) from at least one of the: Process ID (PID) Filter and Process ID (PID) Fetch for terminating the ransomware based on the detection of the anomalous data from the one or more computing devices 206. The termination subsystem 116 comprises the prioritization module 116a. The prioritization module 116a is configured to prioritize the termination of the Process IDs (PIDs) from at least one of the: Process ID (PID) Filter and Process ID (PID) Fetch based on acuteness parameters of the ransomware activity. By employing acuteness parameters tailored to the specific characteristics and behaviour patterns of the ransomware, the prioritization module 116a ensures that the termination process is executed in a manner that optimally addresses the immediate threats posed by ransomware. This strategic approach enables the system 202 to swiftly neutralize the identified ransomware activity, thereby mitigating potential damages and safeguarding the integrity of the one or more computing devices 206.

In an exemplary embodiment, the system 202 further comprises a notification subsystem 306 and a real-time monitoring subsystem 308. The notification subsystem 306 is configured to generate one or more alerts based on the termination of the Process IDs (PIDs) from at least one of the: Process ID (PID) Filter and Process ID (PID) Fetch. The real-time monitoring subsystem 308 is configured to update the system 202 with updated ransomware behaviour patterns and the one or more trap file selection strategies 100A based on ongoing analysis of the registry data and the one or more directory files.

In an exemplary embodiment, the system 202 is configured to detect various crypto-ransomware types by analysing how the ransomware modify the registries and the one or more trap files. To comprehensively understand the modus operandi of the ransomware, an experimental trial is conducted with a detailed study focusing on 20 distinct ransomware variants of the one or more ransomware variants. The experimental trial delved into their behaviours concerning file modifications and the specific registry keys and values they target during the initial phases of execution. However, the true test of an RTR-Shield's (Ransomware Shield based on Trap Files and Registry) efficacy emerges when faced with the challenge of detecting new ransomware variants of the one or more ransomware variants not previously encountered or accounted for during the design phase of the system 202. To evaluate the system 202 performance under real-world conditions, the system 202 is subjected to rigorous testing using four recently emerged ransomware strains such as Dharma, GrandCrab, Phobos, and Plutocrypt. The emerged ransomware strains are acquired from samples collected during the final quarter of 2023, indicating their recent emergence and activity in the cyber landscape.

Remarkably, the RTR-Shield demonstrated exceptional detection capabilities across all tested ransomware samples, including the newly emerged one or more ransomware variants. With an impressive average detection time of merely 3 seconds, the RTR-Shield swiftly identified and flagged the presence of these ransomware threats within the one or more computing devices 206. Moreover, despite the malicious activities of the detected ransomware, RTR-Shield managed to mitigate their impact effectively, resulting in an average loss of only 26 files per incident.

For detailed insights into the detection performance of RTR-Shield against each ransomware variant, refer to the comprehensive results presented in Table 2.

TABLE 2

| | Changes noticed in the | | | | |
|---|---|---|---|---|---|
| | registry activity | | | | |
| | monitoring subsystem 110 | | | Average | Average |
| Ransomware | Key | Value | Value | latency | file loss |
| Variant | Add | Add | Update | (in seconds) | (files) |
| Dharma | Yes | Yes | Yes | 1.9157 | 14 |
| GrandCrab | No | Yes | Yes | 1.6172 | 11 |
| Phobos | Yes | Yes | Yes | 3.9221 | 76 |
| PlutoCrypt | No | Yes | Yes | 3.0824 | 6 |

In an exemplary embodiment, the system 202 adopts a confirmation methodology for identifying the ransomware attack, relying on the simultaneous return of TRUE values from both the registry activity monitoring subsystem 110 and the file trap monitoring subsystem 112. The confirmation methodology occurs within the predetermined timeframes. Once the presence of the ransomware is detected, the system 202 retrieves the PID of the suspended processes from both the registry activity monitoring subsystem 110 and the file trap monitoring subsystem 112 by the malicious PID suspension module. Subsequently, the system 202 terminates the processes associated with the retrieved PID by the ransomware PID termination module effectively stopping the ransomware attack on the one or more computing devices 206. An algorithm for the system 202 is provided below in Algorithm 2:

### Algorithm 2:

```
function registry activity monitoring subsystem
  key_addition_monitor ← CREATE_MONITOR(“key_addition”)
  value_addition_monitor ← CREATE_MONITOR(“value_addition”)
  value_update_monitor ← CREATE_MONITOR(“value_update”)
  while true do
      if (key_addition_monitor.detect( ) ∨ value_addition_monitor.detect( )
value_update_monitor.detect( )) then
          process_list ← GET_RUNNING_PROCESSES
          filtered_list ← FILTER_PROCESSES(process_list)
          RAISE_ALERT(“Suspicious registry activity detected”)
          first data time ← CURRENT_TIME
      end if
    end while
end function
function file trap monitoring subsystem
  trap_monitor ← CREATE_MONITOR(“trap_files”)
  while true do
      if (FileRead_monitor.detect( ) ∨ FileWrite_monitor.detect( ) ∨
FileDelete_monitor.detect( )) on any two selected trap files of the one or more trap files
then
          process_list ← GET_RUNNING_PROCESSES
          filtered_list ← FILTER_PROCESSES(process_list)
          SUSPEND_PROCESSES(filtered_list)
          RAISE_ALERT(“Suspicious file access activity detected”)
          second data_time ← CURRENT_TIME
        end if
      end while
    end function
    function DETECT_RANSOMWARE
        while true do
          if registry activity monitoring subsystem and file trap monitoring subsystem
then
                if (Time_Difference(first data_time, second data_time) ≤ 5s) then
                    process_list ← GET_SUSPENDED_PROCESSES
                    KILL_PROCESSES(process_list)
                    RAISE_ALERT(“Ransomware detected and stopped”)
                  end if
                end if
              end while
            end function
            registry activity monitoring subsystem ( )
            file trap monitoring subsystem ( )
            DETECT_RANSOMWARE( )
```

In an exemplary embodiment, Algorithm 2 depicts an RTR-Shield algorithm associated with the system 202 for early detection and termination of the ransomware. The RTR-Shield algorithm with the registry activity monitoring subsystem 110 and the file trap monitoring subsystem 112 are configured to monitor and analyse the registry activities, as well as observe the one or more trap files. By leveraging the registry activity monitoring subsystem 110 and the file trap monitoring subsystem 112, the RTR-Shield enables the early detection of ransomware.

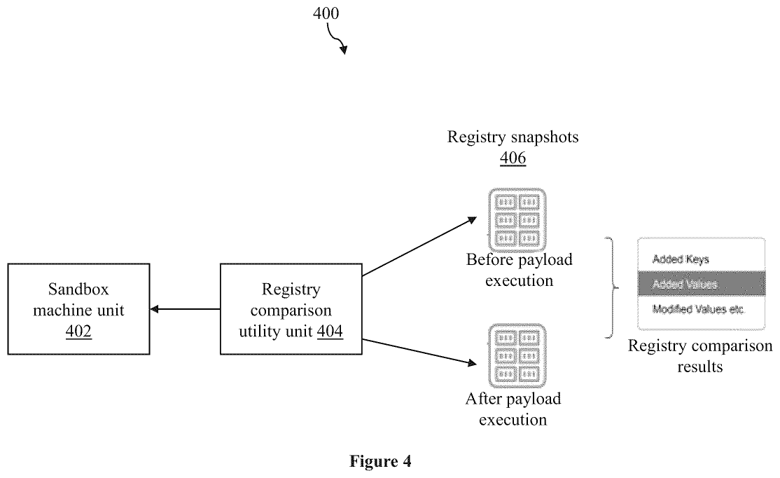

FIG. 4 illustrates an exemplary block diagram depicting a registry data extraction process 400, in accordance with an embodiment of the present disclosure.

In an exemplary embodiment, the registry data extraction process 400 comprises a sandbox machine unit 402, a registry comparison utility unit 404, and the at least two registry snapshots 406. The sandbox machine unit 402 is configured to be installed on the appropriate operating system with the necessary requirements. Further, the sandbox machine unit 402 is also configured to operate in a ‘host-only’ mode in a suitable network. The registry comparison utility unit 404 is a free and open-source tool configured to be installed on the sandbox machine unit 402 of the appropriate operation system. The registry comparison utility unit 404 is adapted to capture the initial registry snapshot 406 to establish a baseline or reference point of the operating system, encompassing information about installed programs, system 202 settings, and user profiles. Additionally, the registry comparison utility unit 404 allows for the comparison of the at least two registry snapshots 406 taken at the predetermined timeframes, facilitating the detection of any changes made to the registry during a specified period. The functionality of the registry comparison utility unit 404 proves valuable in analysing changes induced by the ransomware attack, troubleshooting, and providing valuable insights into the behaviour of the ransomware attack, aiding in the development of rules and measures to detect and mitigate the ransomware at the earliest stages.

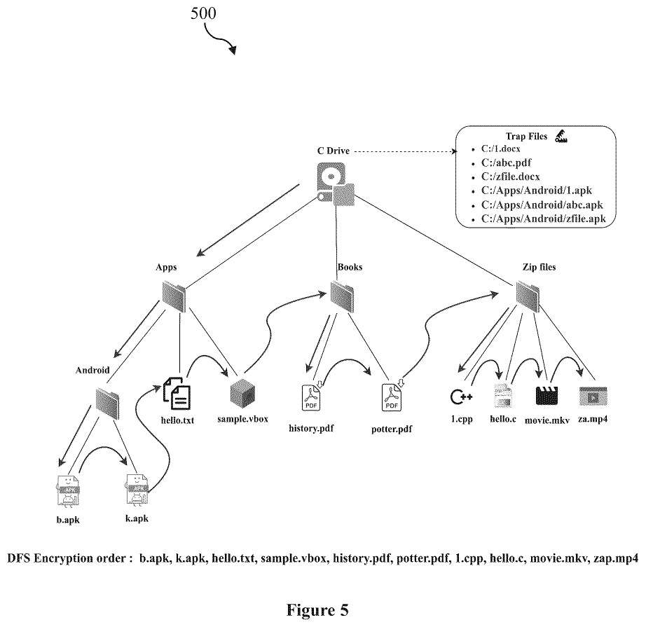

FIG. 5 illustrates an exemplary first graphical flow diagram 500 depicting a strategy for positioning one or more trap files in a depth-first traversal system (DFS) encryption order, in accordance with an embodiment of the present disclosure.

In an exemplary embodiment, the one or more ransomware variants are configured to encrypt files in the DFS encryption order. The one or more ransomware variants comprise twenty-seven families in a pre-encryption stage, including, AtomSilo, AvosLocker, BlackMatter, Blackout, Bubuk, CBAP, Cerber, Conti Cuba, Demonware, GlobeImposter, HelloXD, Hive, Intercobros, Jigsaw, Karma, Lockbit, Lorenz, Magniber, Makop, Mespinoza, MountLocker, Revil, Surtr, Vovabol, Zeppelin, and Zeznzo. In the DFS encryption order, the one or more ransomware variants are configured to encrypt the files in an alphabetical order., For example, as shown in FIG. 3, the DFS encryption order is depicted, such as, b.apk, k.apk, hello.txt, sample.vbox, history.pdf, potter.pdf, 1.cpp, hello.c, movie.mkv, and za.mp4.

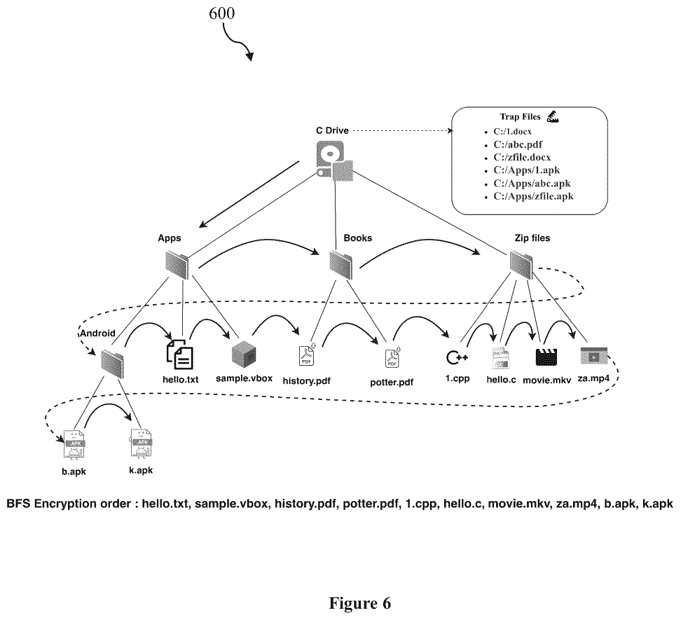

FIG. 6 illustrates an exemplary second graphical flow diagram 600 depicting a strategy for positioning the one or more trap files in a breadth-first traversal system (BFS) encryption order, in accordance with an embodiment of the present disclosure.

The one or more ransomware variants are configured to encrypt files in the BFS encryption order. For instance, in the BFS encryption order, the one or more ransomware variants are configured to encrypt the files by targeting a directory path including, but not limited to, “C:/Users/Public/*”. For example, as shown in FIG. 6, the BFS encryption order is depicted, such as, hello.txt, sample.vbox, history.pdf, potter.pdf, 1.cpp, hello.c, movie.mkv, za.mp4, b.apk, and k.apk.

The one or more trap files are strategically positioned in specific locations on the one or more computing devices 206. The one or more trap files is adapted to act as decoys to attract the ransomware to examine the behaviour of the ransomware at an early stage. By understanding the behaviours exhibited by the one or more ransomware variants, the system 202 is configured to develop supplementary effective strategies for detecting and terminating the ransomware.

In an exemplary embodiment, the one or more ransomware variants are adapted to prioritize encrypting the files with names that include numbers. Furthermore, the one or more ransomware variants are adapted to restrict or intentionally focus on encrypting PowerShell script files. Further, the one or more ransomware variants are also configured to initiate encrypting the files on a desktop of the computer before moving on to other locations on the storage unit 302 of the one or more communication devices 206.

In an exemplary embodiment, the design of the RTR-Shield is configured to achieve early detection by minimizing false positive rates and file loss. The system 202 defines a core functionality of the RTR-Shield in two subsystems: the registry activity monitoring subsystem 110 and the file trap monitoring subsystem 112. Briefly, these subsystems detect abnormal changes in the registry and the one or more trap files individually, signalling the decision generating subsystem 114 upon identification of suspicious activity. Once both subsystems signal the decision generating subsystem 114, it raises an alert, indicating the potential ransomware activity. Following this, the processes are terminated to contain the spread of ransomware and prevent file loss. However, the key aspect is understanding the functioning of these two subsystems to achieve early detection.

TABLE 3

| | | Type of registry |
|---|---|---|
| | | modification was |
| | | noticed (Key |
| | | Addition/Value |
| Registry | | Addition/Value |
| Category | Importance with respect to ransomware activity | Update) |
| VSS | The Volume Shadow Copy Service (VSS) | Key Addition |
| | registry key in the operating system Registry is | |
| | important for ransomware because it can affect | |
| | the ability to create and access shadow copies. | |
| | This makes it harder to restore files after | |
| | encryption, increasing the severity of data loss | |
| | in a ransomware attack. | |
| Restart | The Restart Manager in the operating system | Key Addition |
| Manager | Registry helps manage app restarts during | |
| | updates. However, ransomware can misuse it | |
| | to shut down antivirus processes, allowing the | |
| | ransomware to encrypt files without being | |
| | stopped. | |
| Operating | Ransomware payloads employ the operating | Key Addition |
| system Script | system Script Files (WSFs) that carry | |
| | obfuscated JavaScript code for encryption. To | |
| | execute these payloads, ransomware utilizes | |
| | the operating system wscript.exe utility, | |
| | leading to the modification of the registry key. | |
| FileExts | This registry key in the operating system is | Key Addition |
| | crucial for ransomware as it stores file | |
| | extension associations and configuration | |
| | settings, making it a potential target for | |
| | ransomware to manipulate file associations | |
| | and impact user data accessibility and | |
| | execution of malicious payloads. | |
| Run/RunOnce | The “Run” registry key in the operating system | Value Addition |
| | is crucial for ransomware as it lists programs | |
| | to run automatically at operating system | |
| | startup. Ransomware often targets this key to | |
| | ensure its persistence, allowing it to execute | |
| | and encrypt files upon every boot, maximizing | |
| | its impact. | |
| MuiCache | The MUICache is a part of the operating | Value Addition |
| | system that helps with language support and | |
| | displaying characters. It is responsible for | |
| | storing information about the executable of | |
| | each application and Ransomware generally | |
| | uses MUICache to save temporary files in case | |
| | a real antivirus eliminates them. | |
| Operating | Ransomware uses the operating system search | Value Update |
| system | option to traverse directories for file | |
| Search | encryption. Operating system Search hive | |
| | values get updated during this operation. | |

The ransomware execution in its early phases manifest in the registry, including adding new keys, adding values, and updating existing values. As outlined in Table 3, early signs of ransomware execution encompass activities such as deleting shadow copies, employing a restart manager to turn off antivirus applications, adding a run key for persistence, introducing new file extensions, storing duplicates in cached folders, and executing extensive file search operations. The ransomware may perform many of these operations to achieve its objective. Given that all these indications manifest as at least one of the: key additions, value additions, and value updates. When at least one of the: key additions, value additions, and value updates detects an anomaly, the registry activity monitoring subsystem 110 generates the first data and transmit it to the decision generating subsystem 114, indicating a suspicious modification. Concurrently, the PID FILTER module is promptly invoked to identify the suspicious process IDs associated with the ransomware and pass them to the termination subsystem 116. This facilitates the swift termination of the ransomware-related processes once the decision generating subsystem 114 raises the alert at a later stage. Table 4 details the modifications identified by the registry activity monitoring subsystem 110 for the one or more ransomware variants.

TABLE 4

| Ransomware variants | Key Add | Value Add | Value Update |
|---|---|---|---|
| AtomSilo | Yes | Yes | Yes |
| AvosLocker | Yes | Yes | Yes |
| Babuk | Yes | Yes | Yes |
| BlackMatter | Yes | Yes | Yes |
| BlackOut | Yes | Yes | Yes |
| Cerber | Yes | Yes | Yes |
| Conti | Yes | No | Yes |
| Cuba | No | Yes | Yes |
| Demonware | No | Yes | Yes |
| GlobeImposter | Yes | Yes | Yes |
| HelloXD | No | Yes | Yes |
| Intercobros | No | Yes | Yes |
| Jigsaw Locker | No | No | Yes |
| Karma | No | Yes | Yes |
| LockBit | Yes | Yes | Yes |
| Lorenz | Yes | Yes | Yes |
| Magniber | Yes | Yes | Yes |
| Makop | No | Yes | Yes |
| Mespinoza | No | Yes | Yes |
| MountLocker | Yes | Yes | Yes |

In an exemplary embodiment, the one or more trap files are not directly select based on file access patterns, as outlined in Table 5. Instead, employing the data mining models to determine the directory paths for the one or more trap files may provide optimal results for early detection. The data mining models are configured to minimise latency, use the pre-existing one or more directory files as the one or more trap files, with no need of suffixes or prefixes to the one or more trap files, non-heuristic method.

TABLE 5

| | Type of | | Access | |
|---|---|---|---|---|
| Ransomware | Ransom Note | Access | Public User | Directory |
| variants | displayed? | RecycleBin | Directory | Traversal |
| AtomSilo | WebPage | No | Yes | Alphabetic |
| AvosLocker | Text | No | No | Reverse |
| | | | | Alphabetic |
| Babuk | Text | Yes | No | Alphabetic |
| BlackMatter | Text | Yes | No | Reverse |
| | | | | Alphabetic |
| Blackout | Text | Yes | No | Alphabetic |
| Cerber | WebPage | Yes | No | Alphabetic |
| Conti | Text | Yes | No | Alphabetic |
| Cuba | Text | No | No | Alphabetic |
| DemonWare | Text | Yes | No | Alphabetic |
| GlobeImposter | WebPage | No | Yes | Reverse |
| | | | | Alphabetic |
| Hello XD | Text | No | No | Alphabetic |
| Intercobros | Text | No | No | Alphabetic |
| Jigsaw | Text | No | No | Alphabetic |
| Karma | Text | No | No | Alphabetic |
| LockBit | Text | Yes | No | Alphabetic |
| Lorenz | WebPage | No | No | Alphabetic |
| Magniber | WebPage | No | Yes | Alphabetic |
| Makop | Text | Yes | No | Alphabetic |
| Mespinoza | Text | Yes | Yes | Alphabetic |
| MountLocker | WebPage | No | No | Alphabetic |
| Revil | Text | No | Yes | Alphabetic |

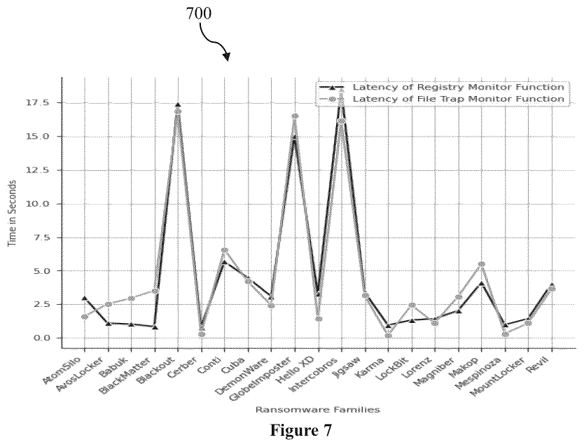

FIG. 7 illustrates an exemplary graphical representation 700 depicting a comparison of latency between the registry activity monitoring subsystem 110 and the file trap monitoring subsystem 112, in accordance with an embodiment of the present disclosure.

In an exemplary embodiment, evolution of the RTR-shield associated with the system 202 is disclosed. The RTR-Shield primarily on aspects such as file loss, latency in detecting ransomware, ability to detect the new ransomware variants, false positive rate, and performance load on the one or more computing devices 206. The experimental evaluation setup includes a computing device 206 of the one or more computing devices 206 with Windows 10 Operating system, 8 GB RAM, and 256 GB storage. It contains 14,237 user files (excluding essential operating system files), with 34 of them selected as traps. Table 6 depicting detailed results obtained during the evaluation of RTR-Shield against the one or more ransomware variants.

TABLE 6

| | Average Latency | Average FileLoss |
|---|---|---|
| Ransomware Family | (in seconds) | (files) |
| AtomSilo | 3.2090511 | 11 |
| AvosLocker | 2.7162412 | 27 |
| Babuk | 3.1039094 | 90 |
| BlackMatter | 3.7151713 | 102 |
| Blackout | 17.6102061 | 12 |
| Cerber | 0.9810913 | 7 |
| Conti | 6.7706005 | 13 |
| Cuba | 4.66855 | 9 |
| DemonWare | 3.2815851 | 10 |
| GlobeImposter | 16.7152783 | 8 |
| Hello XD | 3.4508442 | 12 |
| Intercobros | 18.6863997 | 24 |
| Jigsaw | 3.6060265 | 74 |
| Karma | 1.1370605 | 10 |
| LockBit | 2.6358876 | 106 |
| Lorenz | 1.6240064 | 6 |
| Magniber | 3.2625101 | 15 |
| Makop | 5.6949733 | 7 |
| Mespinoza | 1.169422 | 6 |
| MountLocker | 1.6267757 | 7 |
| Revil | 4.2040994 | 10 |

We define latency as the time RTR-Shield takes to terminate the ransomware processes once it identifies suspicious behaviour from the file trap monitor function and registry monitor function. We examined 20 ransomware variants, some of which quickly initiate encryption, while others take more time before starting encryption. Our analysis revealed that BlackOut, GlobeImposter, and Intercobros variants are not very prompt in entering the encryption phase after payload execution. We evaluated five samples of each ransomware variant, and the respective average latency and file loss for each ransomware variant are presented in Table 5. The average latency across all 20 ransomware variants is 5.23 seconds, and excluding slow encryption variants further reduces it to 3.15 seconds. This statistic indicates that our proposed tool, RTR-Shield, effectively contain modern one or more ransomware variants within 3.15 seconds of execution. The latency observed for the individual components, i.e., the RAMB and the FTMB for all the 20 ransomware variants, is depicted in FIG. 7.

The RTR-Shield associated with the system 202 demonstrated an average loss of 26 files out of 14,237 user files during ransomware activity. This equates to approximately 0.1826% of files being affected. This implies that, on average, 99.8173% of files remain unaffected when the system 202 is active. LockBit and BlackMatter are mentioned as ransomware variants that caused elevated file loss due to their rapid encryption methods and use of parallel threading. The file loss statistics of the system 202 are compared with other contemporary approaches. The contemporary approache-1 (Lee et al.) reported 200 file losses, the contemporary approache-2 (RTrap) reported 18 out of 10,000 files, contemporary approache-3 (RWGuard) reported 288 file losses, contemporary approache-4 (DeepGuard) reported 296 file losses, and contemporary approache-5 (File Entropy) reported 163 file losses. In contrast, RTR-Shield achieved an average file loss of 26 out of 14,000 files. This indicates that RTR-Shield outperforms the other approaches in terms of minimizing file loss during the ransomware attacks. The deception rate, which represents the percentage of file loss, is highlighted as a metric for comparison. The RTR-Shield achieved the optimum deception rate at 0.1826% compared to the other contemporary approaches.

In an exemplary embodiment, the system 202 is configured to reduce the false positives. The false positives are occurrences where the system 202 incorrectly identifies benign applications or user interactions with endpoint of the one or more computing devices 206 as ransomware activity, resulting in the erroneous termination of benign processes. To assess this scenario, a thorough analysis is conducted for encompassing various benign applications, including antivirus programs, file encryption tools, file search programs, browsers, file copy tools, file archivers, and software Integrated Development Environments (IDEs). Throughout the installation or execution of these applications, the system 202 consistently demonstrated a high level of accuracy by not raising any false alarms indicative of ransomware activity.

In the context of the registry activity monitoring subsystem 110, certain benign applications, such as antivirus programs or browsers, may add run key values to ensure their immediate startup following the one or more computing devices 206 reboots. Moreover, during the experimentation, we noted that software IDEs like Visual Studio Code and Code::Blocks may update Windows search-related registry values when conducting program file searches with associated extensions. The impact of these benign applications on the registry activity monitoring subsystem 110 is detailed in Table 7. Despite the registry activity monitoring subsystem 110 signalling the decision generating subsystem 114 in response to these activities, no false flags are raised because these applications do not modify the existing one or more trap files within the one or more computing devices 206.

TABLE 7

| | | Changes Noticed in the registry | | |
|---|---|---|---|---|
| | | monitoring function (RAMB) | | |
| Application | Application | Key | Value | Value |
| Name | Type | Add | Add | Update |
| VeraCrypt | File Encryption | No | No | No |
| AXCrypt | File Encryption | No | No | No |
| 360_Security | Antivirus | No | Yes | No |
| ESET_Security | Antivirus | No | Yes | No |
| Mcafee Scan | Anti Virus | No | Yes | No |
| Plus | | | | |
| Everything | File Search | No | No | No |
| UltraSearch | File Search | No | No | No |
| FireFox | Browser | No | No | No |
| Opera | Browser | No | Yes | No |
| CodeBlocks | Software IDE | No | No | Yes |
| Microsoft | Software IDE | No | No | Yes |
| VSCode | | | | |
| TeraCopy | File Copy | No | No | No |
| ThunderBird | Mail Client | No | No | No |
| PowerISO | Disk Image | No | Yes | No |
| 7Z | File Archiver | No | No | No |

In another scenario, if the end user unintentionally modifies at least one trap file (through actions like write, delete, or rename) of the one or more trap files. This modification of the at least one trap file not disrupt the existing detection of the system 202. This is due to the requirement that at least two trap files of the one or more trap files must be affected by the file modification to trigger a signal to the decision generating subsystem 114, ultimately leading to the suspension of the process responsible for the file modification. Even in such cases, where the one or more trap files are unintentionally altered, the termination of a benign process is not occurred because the registry activity monitoring subsystem 110 did not signal simultaneously. To validate this capability, an experiment is conducted with an extensive analysis over a period of 15 days, focusing on a single endpoint. Throughout this evaluation period, the system 202 consistently demonstrated its robustness by not raising any false alarms during various user interactions or benign application usage scenarios. This confirms a resilience of the system 202 in distinguishing between legitimate user actions and ransomware activity, thereby ensuring the uninterrupted operation of the system 202.

Numerous advantages of the present disclosure may be apparent from the discussion above. In accordance with the present disclosure, the computer-implemented method and the system for early detection and termination of ransomware is disclosed. The computer-implemented method and the system assists to render priority to the pre-encryption behaviour of the ransomware attacks by identifying critical indicators of the ransomware attack at the registry level. This emphasis enables the computer-implemented method and the system to detect the ransomware attack at the early stage, enabling a proactive defence strategy. The computer-implemented method and the system captures crucial changes made by the ransomware attack at the registry level during the pre-encryption phase. This approach ensures maximum file safety and minimizes the impact of the ransomware attacks on a larger scale. Furthermore, the computer-implemented method and the system thoroughly designs the file traps within the one or more computing devices to further enhance protection. By combining the registry activity monitoring subsystem and the file trap monitoring subsystem, the computer-implemented method and the system offers superior protection, effectively preventing extensive file encryption, and terminate the impact of the ransomware attack.

While specific language has been used to describe the present disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

What is claimed is:

1. A computer-implemented method for terminating ransomware based on detection of anomalous data, comprising:
generating, by a registry activity monitoring subsystem, first data associated with the anomalous data based on analysis of registry data in one or more computing devices;
generating, by a file trap monitoring subsystem, second data associated with the anomalous data based on analysis of one or more trap files associated with one or more directory files in the one or more computing devices;
retrieving, by a decision generating subsystem, Process IDs (PIDs) from at least one of a: Process ID (PID) Filter and Process ID (PID) Fetch associated with the first data and the second data to initiate a ransomware termination process; and
terminating, by a termination subsystem, the retrieved Process IDs (PIDs) from at least one of the: Process ID (PID) Filter and Process ID (PID) Fetch to terminate the ransomware based on detection of the anomalous data from the one or more computing devices.

2. The computer-implemented method of claim 1, wherein the first data generated upon detecting at least one of: key additions, value additions, and value updates in the registry data indicating a ransomware activity within a registry of the one or more computing devices.

3. The computer-implemented method of claim 1, wherein the one or more trap files are produced based on at least one of: engaging a pre-existing one or more directory files and selecting additional trap files in the one or more directory files.

4. The computer-implemented method of claim 3, wherein the pre-existing one or more directory files comprises at least one of: system directories, user directories, and temporary directories to optimise the generation of the second data.

5. The computer-implemented method of claim 1, wherein the second data is generated based on analysing the one or more trap files by detecting at least one of a: file write, file delete, and file rename operations indicative of the ransomware activity within the one or more computing devices,
the second data is generated based on detecting at least one of the: file write, file delete, and file rename operations of at least two trap files of the one or more trap files for averting false positive alerts.

6. The computer-implemented method of claim 1, wherein the file trap monitoring subsystem is configured with data mining models to extract frequent file access patterns from historical file modification data associated with the one or more directory files for engaging the one or more trap files,
the data mining models comprises at least one of: association rule mining, sequential pattern mining, and frequency rule mining to identify potential one or more trap file locations.

7. The computer-implemented method of claim 1, wherein the decision generating subsystem is configured with a time synchronization module,
the time synchronization module configured to synchronise timestamps data associated with the first data and the second data to confirm the ransomware activity in the one or more computing devices,
the timestamps data comprises a predetermined timeframe for receiving the second data upon receiving the first data,
the predetermined timeframe ranges between 3 seconds and 10 seconds.

8. The computer-implemented method of claim 1, wherein the decision generating subsystem is configured with a restart module,
the restart module is configured to restart the terminated Process IDs (PIDs) from at least one of the: Process ID (PID) Filter and Process ID (PID) Fetch if the decision-generating subsystem detects the second data generation is beyond the predetermined timeframe.

9. The computer-implemented method of claim 1, wherein the termination subsystem comprises a prioritization module,
the prioritization module configured to prioritize the termination of the Process IDs (PIDs) from at least one of the: Process ID (PID) Filter and Process ID (PID) Fetch based on acuteness parameters of the ransomware activity.

10. A computer-implemented system for terminating ransomware based on detection of anomalous data, comprising:
one or more hardware processors operatively connected to one or more computing devices;
a computer readable storage unit operatively connected to the one or more hardware processors, wherein the computer readable storage unit comprises a set of program instructions in form of a plurality of subsystems, configured to be executed by the one or more hardware processors, wherein the plurality of subsystems comprises:
a registry activity monitoring subsystem configured to generate first data associated with the anomalous data based on analysing registry data in the one or more computing devices;
a file trap monitoring subsystem configured to generate second data associated with the anomalous data based on analysing one or more trap files associated with one or more directory files in the one or more computing devices;
a decision generating subsystem configured to initiate a ransomware termination process upon retrieving Process IDs (PIDs) from at least one of a: Process ID (PID) Filter and Process ID (PID) Fetch associated with the first data and the second data; and
a termination subsystem configured to terminate the retrieved Process IDs (PIDs) from at least one of the: Process ID (PID) Filter and Process ID (PID) Fetch for terminating the ransomware based on detection of the anomalous data from the one or more computing devices.

11. The computer-implemented system of claim 10, comprises a notification subsystem and a real-time monitoring subsystem,
the notification subsystem is configured to generate one or more alerts based on termination of the Process IDs (PIDs) from at least one of the: Process ID (PID) Filter and Process ID (PID) Fetch; and
the real-time monitoring subsystem configured to update the computer-implemented system with updated ransomware behaviour patterns and one or more trap file selection strategies based on ongoing analysis of the registry data and the one or more directory files.

12. A non-transitory computer readable storage unit having instructions stored therein that when executed by one or more hardware processors, cause the one or more hardware processors to execute operations of:
generating first data associated with the anomalous data based on analysis of registry data in one or more computing devices;
generating second data associated with the anomalous data based on analysis of one or more trap files associated with one or more directory files in the one or more computing devices;
retrieving Process IDs (PIDs) from at least one of a: Process ID (PID) Filter and Process ID (PID) Fetch associated with the first data and the second data to initiate a ransomware termination process; and
terminating the retrieved Process IDs (PIDs) from at least one of the: Process ID (PID) Filter and Process ID (PID) Fetch to terminate the ransomware based on detection of the anomalous data from the one or more computing devices.

13. The non-transitory computer readable storage unit of claim 12, wherein the first data generated upon detecting at least one of: key additions, value additions, and value updates in the registry data indicating a ransomware activity within a registry of the one or more computing devices.

14. The non-transitory computer readable storage unit of claim 12, wherein the one or more trap files are produced based on at least one of: engaging a pre-existing one or more directory files and selecting additional trap files in the one or more directory files.

15. The non-transitory computer readable storage unit of claim 14, wherein the pre-existing one or more directory files comprises at least one of: system directories, user directories, and temporary directories to optimise the generation of the second data.

16. The non-transitory computer readable storage unit of claim 12, wherein the second data is generated based on analysing the one or more trap files by detecting at least one of a: file write, file delete, and file rename operations indicative of the ransomware activity within the one or more computing devices,
the second data is generated based on detecting at least one of the: file write, file delete, and file rename operations of at least two trap files of the one or more trap files for averting false positive alerts.
